(19) United States
(12) Patent Application Publication
(10) Pub. No.: US 2024/0261759 A1
(43) Pub. Date: Aug. 8, 2024

(54) Method Of Manufacture Of UiO-66 Having Specific Micropore Volume

(71) Applicant: ExxonMobil Technology and Engineering Company, Annandale, NJ (US)

(72) Inventors: Matthew T. Kapelewski, Lambertville, NJ (US); Joseph M. Falkowski, Hampton, NJ (US); Dominick A. Zurlo, Easton, PA (US); Mary S. Abdulkarim, Palisades Park, NJ (US)

(21) Appl. No.: 18/561,646

(22) PCT Filed: May 31, 2022
(86) PCT No.: PCT/US2022/031518

§ 371 Date: Nov. 16, 2023

Related U.S. Application Data
(60) Provisional application No. 63/194,239, filed on May 28, 2021.

(51) Int. Cl. B01J 20/22; B01J 20/28; B01J 20/30

(52) U.S. Cl. CPC B01J 20/226; B01J 20/28064; B01J 20/28066; B01J 20/28071; B01J 20/28073; B01J 20/3078; B01J 2531/48

(57) ABSTRACT

Provided are methods of making a MOF UiO-66 comprising reacting zirconium oxychloride with terephthalic acid or derivative thereof and acetic acid in a solvent to provide a reaction solution; diluting the reaction solution with water, heating the diluted reaction solution and reducing the reaction temperature of the reaction mixture to provide the MOF UiO-66 having a micropore volume greater than or equal to 0.45 cc/g and a crystal size of between about 20 nm and about 1000 nm. Also provided are methods of making a MOF UiO-66 where a zirconium hydroxide acetate and zirconium hydroxide are reacted with a carboxylic acid or derivative thereof and acetic acid in a solvent to produce the metal-organic framework MOF UiO-66 having a micropore volume at least 0.35 cc/gram.

### CROSS REFERENCE TO RELATED APPLICATIONS

The present application claims priority to and the benefit of U.S. Provisional Application No. 63/194,239 filed on May 28, 2021, which is hereby incorporated by reference in its entirety.

### FIELD

The present disclosure relates to aqueous synthesis of making a metal-organic framework UiO-66 to increase surface area, micropore volume and synthesis yields, and without impurities or unintended deficiencies.

### BACKGROUND

The metal-organic framework, UiO-66 offers high stability, a tunable structure, and relative ease of synthesis. Scalable syntheses of making this metal-organic framework, however, require toxic and flammable solvents. Different synthetic techniques which employ water, either as the majority solvent or as a constituent thereof, have been tried. Prior art aqueous synthesis protocols create UiO-66 in low yields with impurities and/or deficiencies in chemistry, micropore structure, surface area, micropore volume and adsorption capacity of UiO-66.

### SUMMARY

Provided herein are methods of making a MOF UiO-66 comprising (1) reacting zirconium oxychloride with terephthalic acid or derivative thereof and acetic acid in a solvent to provide a reaction solution; (2) diluting the reaction solution with at least about 10 vol. % of water to provide a diluted reaction solution; (3) heating the diluted reaction solution to a reaction temperature of at least 120° C. for at least 4 hours to provide a reaction mixture; and (4) reducing the reaction temperature of the reaction mixture to provide the MOF UiO-66 having a micropore volume greater than or equal to 0.45 cc/g and a crystal size of between about 20 nm and about 1000 nm. In an aspect, the terephthalic acid derivative is not soluble in water. In an aspect, the carboxylic acid is selected from 1,4-benzenedicarboxylate or derivative thereof, 1,2,4-benzene tricarboxylic acid, 1,2,4,5-benzene tetracarboxylic acid, 2-nitro-1,4, benzene dicarboxylic acid or mixtures thereof. In an aspect, the MOF UiO-66 produced has a surface area of between about 900 m²/g and about 1550 m²/g as measured by nitrogen BET.

Also provided are methods of making a MOF UiO-66 comprising reacting one or more of zirconium hydroxide acetate and zirconium hydroxide with a carboxylic acid or derivative thereof and acetic acid in a solvent to provide a reaction solution that produces the metal-organic framework MOF UiO-66 having a micropore volume at least 0.35 cc/gram. In an aspect, the carboxylic acid is 2-amino-1,4-benzene dicarboxylic acid. In an aspect, this method further comprises diluting the reaction solution with water in an amount less than or equal to 50 volume percent of the solvent to provide a diluted reaction solution. In an aspect, the diluted reaction solution to a reaction temperature of at least 85° C. In an aspect, the diluted reaction solution is heated for at least 4 hours. In an aspect, the MOF UiO-66 has a micropore volume of between about 0.1 and about 1.0 cubic centimeters per gram.

These and other feature and attributes of the disclosed methods and compositions of the present disclosure and their advantageous applications and/or uses will be apparent form the detailed description which follows.

### BRIEF DESCRIPTION OF THE DRAWINGS

To assist those of ordinary skill in the relevant art in making and using the subject matter hereof, reference is made to the appended drawings, wherein:

FIG. TA and FIG. 1B provide a comparison of powder x-ray diffraction patterns for MOF UiO-66 synthesized in a 600 mL, 2 L, and 5 gallon reactors of Example 1.

FIG. 2 shows the N₂ uptake at 77 K of multiple 2 L and 5 gallon scale reactions used to make MOF UiO-66 of Example 1.

FIG. 3A and FIG. 3B are SEM images providing a comparison of the crystal sizes of MOF UiO-66 produced in the 2 L and 5 gallon reactors of Example 1.

FIG. 4A and FIG. 4B show powder x-ray diffraction patterns of the MOF UiO-66 synthesized with Zr(OAc)ₓ(OH)₄₋ₓ of Example 2.

FIG. 5 are the N₂ adsorption isotherms at 77 K used to calculate BET surface areas for the MOF UiO-66 synthesized using Zr(OAc)ₓ(OH)₄₋ₓ as a starting material.

FIG. 6 is an N₂ adsorption isotherm at 77 K used to calculate the micropore volume and BET surface area of MOF UiO-66 of Example 2 synthesized with ZrOCl₂ and a high acetic acid content.

FIG. 7 are powder x-ray diffraction patterns of the water-containing MOF UiO-66 syntheses of Example 3.

FIG. 8 are powder x-ray diffraction patterns of MOF UiO-66 syntheses with varied acid concentration in Example 3.

FIG. 9 are powder x-ray diffraction patterns of MOF UiO-66 washed in various ways.

FIG. 10 is the N₂ adsorption isotherm at 77 K for MOF UiO-66 using a 40% water solvent.

FIG. 11A and FIG. 11B shows a structure of UiO-66 and its secondary building unit, Zr₆O₃₂ respectively.

### DETAILED DESCRIPTION

Before the present compounds, components, compositions, and/or methods are disclosed and described, it is to be understood that unless otherwise indicated this disclosure is not limited to specific compounds, components, compositions, reactants, reaction conditions, ligands, catalyst structures, metallocene structures, or the like, as such may vary, unless otherwise specified. It is also to be understood that the terminology used herein is for the purpose of describing particular aspects only and is not intended to be limiting.

All numerical values within the detailed description and the claims herein are modified by “about” or “approximately” the indicated value, taking into account experimental error and variations.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

Metal-organic frameworks comprise organic linkers (referred to also as “ligands”) that bridge metal nodes (referred to as “secondary building units” or “SBUs”) through coordination bonds and can self-assemble to form a coordination network. Tunable topologies, either through isoreticular expansion or functionalization of the organic linker/metal node, make metal-organic frameworks customizable for different applications ranging from catalytic transformations to adsorption and separations to biomedical applications. Metal-organic frameworks have properties useful in industrial applications including, but not limited to, gas adsorption, gas separations, catalysis, heating/cooling, batteries, gas storage, sensing, and environmental remediation.

Stability of a metal-organic framework (“MOF”) can be attributed to strong interactions between ions of low polarizability such as carboxylates and trivalent metals. Stable metal-organic frameworks were initially relegated to phthalate-based MOFs derived from trivalent cations, namely Al³⁺, Fe³⁺, and Cr³⁺. Subsequently, other multivalent cations such as Zr⁴⁺, Hf⁴⁺, or Ti⁴⁺ were utilized to provide additional robust frameworks. A metal-organic framework UiO-66 was first discovered by reacting zirconium salts with linear dicarboxylic acids. Cavka, J. H. et al., (2008) “A New Zirconium Inorganic Building Brick Forming Metal Organic Frameworks with Exceptional Stability,”J. Am. Chem. Soc., v. 130, pp. 13850-13851. At the time of its discovery, UiO-66 exhibited one of the highest connectivity of any known metal-organic framework.

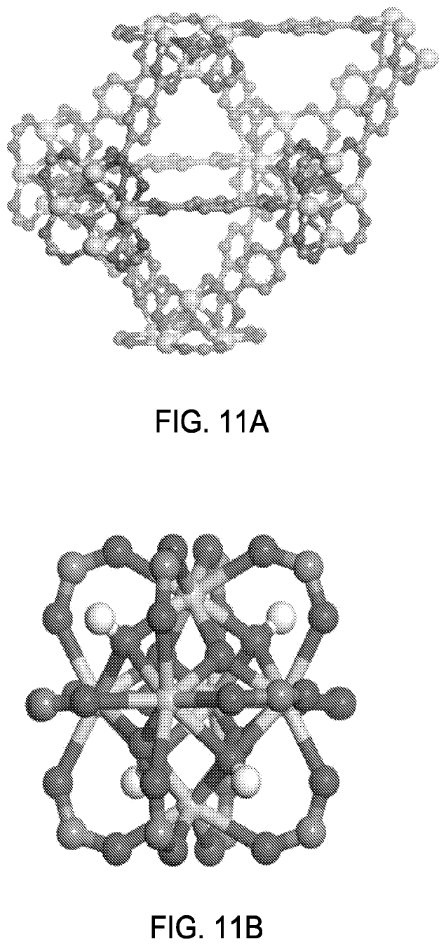

As shown in FIG. 11A and FIG. 11B, the metal-organic framework UiO-66 is constructed of Zr₆O₃₂ nodes (secondary building units) that are bridged by 1,4-benzenedicarboxylate (“BDC”) linkages. Each SBU is 12-connected and when fully connected, forms a face-centered cubic lattice (“FCU”). This lattice contains two distinct cage structures, an octahedral cage with a diameter of ˜1 Å flanked by smaller tetrahedral cages with a diameter of ˜8 Å. Structural analysis of UiO-66 revealed nuances of the original metal-organic framework. Valenzano, L. et al. (2011) “Disclosing the Complex Structure of UiO-66 Metal Organic Framework: A Synergic Combination of Experiment and Theory,”Chem. Mater., v. 23, pp. 1700-1718. Missing linker values ranging from 8% to 50% were reported. As the degree of missing linkers increased, thermal stability decreased.

Original synthetic protocols to make UiO-66 included heating a reaction of ZrCl₄ with BDC in dimethylformamide (“DMF”) to yield polycrystalline powder. Subsequently, this synthetic protocol was modified to include monocarboxylic acids to moderate the syntheses and form 200 nm sized single crystals. Schaate, A. et al. (2011) Chem. Eur. J., v. 17, pp. 6643-6651. Depending on the type of modulator (acetic acid versus benzoic acid), surface area differed from the original UiO-66 produced. The carboxylic acid modulator has become ubiquitous in synthesizing zirconium-based metal-organic frameworks. While concentration of the modulators can be used to control linker vacancies, pKa of the carboxylic acid modulator is an equally puissant variable.

Because UiO-66 has been shown to have exceptional thermal and chemical stability, UiO-66 has been synthetized though various synthetic pathways, primarily solvothermal. Prior art synthetic conditions have included a reaction of a zirconium salt (a chloride or oxychloride) with a linear dicarboxylic acid. An early version of UiO-66 was made with terephthalic acid. Functionalized derivatives as well as isoreticular analogs resulted (i.e., those comprised of longer linear diacids such as 4,4′-biphenyldicarboxylic acid). Most common were high-boiling aprotic solvents, often utilizing N,N-dimethylformamide (“DMF”).

On the other hand, aqueous synthesis of UiO-66 has consistently resulted in impurities and/or deficiencies in the chemistry, micropore structure, surface area and micropore volume, and/or adsorption capacity of UiO-66. For example, an impure variant of UiO-66 has been made with water and acetic acid. Hu, Z. et al. (2015) “A Modulated Hydrothermal (MHT) Approach for the Facile Synthesis of UiO-66-Type MOFs,” J Am. Chem. Soc., v. 54, pp. 4862-4868. Due to the low solubility of terephthalic acid in water, this approach was found challenging while requiring a corrosive mixture due to the lower pH. When modulator-to-terephthalic acid ratio was increased, additional impure variants were made. To obtain a crystalized product, zirconium (IV) nitrate was used as ae zirconium source. Here, UiO-66-type materials were produced only from the functionalized organic starting materials (i.e., amino terephthalic acid). Hu, Z. et al. (2016) “Modulator Effects on the Water-Based Synthesis of Zr/Hf Metal-Organic Frameworks: Quantitative Relationship Studies between Modulator, Synthetic Condition, and Performance,” J. Am. Chem. Soc., v. 16, pp. 2295-2301. In the case of unfunctionalized terephthalic acid, impurities were observed both in the X-ray diffraction pattern and the SEM images of the MOF UiO-66.

In another method, a water-soluble zirconium source in the form of zirconium sulfate was shown to interact strongly with the zirconium secondary building unit of the MOF, causing a change in structure. Reinsch, H. et al. (2015) “Green Synthesis of Zirconium MOFs”, Crys. Eng. Comm., v. 17, pp. 4070-7074. Instead of the traditional 12-connected nodes that comprise UiO-66, the researchers observe 8-connected nodes. This 8-connected network shows reduced surface areas compared to the traditional solvothermal synthesis. Id.

While certain prior art methods have added water into N,N-dimethylformamide-based syntheses, inclusion of water is usually at low levels, often on par with the concentration of the metal source, or as a diluent for an HCl modulator. Vo, K. et al. (2019) “Facile Synthesis of UiO-66(Zr) Using a Microwave-Assisted Continuous Tubular Reactor and Its Application for Toluene Adsorption,” J. Am. Chem. Soc., v. 19, pp. 4949-4956. The amount of water does not arise to a significant fraction of the bulk solvent.

Similarly, the role of water as a modulator in hafnium-containing frameworks isostructural to that of UiO-66 has been proposed. Firth, F. et al. (2019) “Engineering New Defective Phases of UiO Family Metal-Organic Frameworks with Water,” J Mater. Chem., v. 7, pp. 7459-7469. Using a solution of DMF and formic acid, the water concentration and its effect on synthesis of Hf-UiO-67 (the biphenyl congener of UiO-66) was interrogated. When using a 20% solution of formic acid in DMF, the incorporation of even small amounts of water resulted in the formation of the hns phase, which is a 2-dimensional nanosheet structure.

Holistically, while water-based solvent systems have been implemented in the syntheses of functionalized UiO-66 (as well as those of other zirconium-based frameworks comprised of other water-soluble linkers), the use of water to synthesize a conventional UiO-66 has been scarce. Even in the paucity of prior art methods that do exist, low quality materials often result. Despite these challenges, the burden of toxic solvents must be addressed and alternatives to traditional formamide-based preparations are needed. Organic solvents are an impediment to the scale-up of MOF materials because high cost and safety, health and environmental management concerns. Consequently, aqueous or solvent-free methods of synthesizing UiO-66 are desirable.

Though various synthetic protocols for UiO-66 are known, creating material at scale with a specific micropore volume is crucial to synthesizing the requisite quantities for testing and implementation. The present methods provide tunable synthesis, in which the metals, ligands, and synthetic conditions are chosen to make a specific framework material, MOF UiO-66 with control over porosity, pore size, crystal size, and many other properties of the synthesized material.

Provided herein are methods of making a MOF UiO-66 having a micropore volume of greater than or equal to 0.45 cc/gram as required for applications of naphthene and paraffin class-based separation. The present methods of making the MOF UiO-66 also provide a scale of up to 750 g of activated, de-solvated MOF UiO-66 per batch in a five (5) gallon reactor. As used herein, the term “MOF UiO-66” refers to a UiO-66 metal-organic framework made in accordance with the present methods.

In addition to the aforementioned synthetic protocols which utilize a lab-scale synthetic procedure, we have developed novel procedures which utilize unique reactants, solvents, and/or a combination thereof to address the challenges in scaling up the manufacture of MOF UiO-66. First, the utilization of chloride salts of zirconium can lead to corrosion issues which pose development issues at larger scales. Second the use of large quantities of acetic acid can add to cost while also posing metallurgical problems. Finally, the use of the large quantities of polar aprotic solvents presents a cost and safety challenge to scaling these materials up in a meaningful way. The present methods address each of these concerns.

We have found that zirconium hydroxide as well as zirconium hydroxide acetate are competent starting materials for the synthesis of MOF UiO-66, obviating the need for corrosive chloride solutions. Additionally, we have shown that dilution of the reaction mixture with water provides multiple benefits. While the dilution of up to 50 wt. % can result in lower costs due to the organic solvent, it also decreases the optimal acetic acid concentration, decreasing the corrosivity of the reaction mixture. Additionally, replacing any quantity of organic solvents with significantly less expensive water at scale is beneficial for scale-up. In sum, the present methods offer multiple advances which could be used individually or in concert to improve the synthesis of MOF UiO-66 having a micropore volume suitable for gas separations and to provide alternative options for method of manufacture for larger scale crystallizations of this material.

MOF UiO-66 can have additional functionality built into the linker, including functional groups that project into the pores of the metal-organic framework. The present methods are directed to synthesis of the metal-organic framework MOF UiO-66, a zirconium-based MOF comprised of Zr₆O₄(OH)₄ nodes connected by doubly-deprotonated terephthalic acid (benzene-1,4-dicarboxylate). MOF UiO-66 is produced with consistent micropore volume for use in separation applications and in large quantities. Lastly, as described in the examples below, the present methods of manufacture of MOF UiO-66 utilize specific metal salts, water content, and other controlled parameters which result in a material of sufficient quality for separation applications.

MOF UiO-66 produced via the present methods is useful for naphthene/paraffin class-based separation. Separation performance, however, is dependent on the micropore volume of the metal-organic framework. Micropore volume can vary based on the number of missing linkers and/or missing nodes of the metal-organic framework (also known as defects). A specific, minimum micropore volume of ˜0.45 cc/g, or 0.50 cc/g, is required to affect the naphthene/paraffin separation.

Provided herein are methods of making a MOF UiO-66 comprising (1) reacting zirconium oxychloride with terephthalic acid or derivative thereof and acetic acid in a solvent to provide a reaction solution; (2) diluting the reaction solution with at least about 10 vol. % of water to provide a diluted reaction solution; (3) heating the diluted reaction solution to a reaction temperature of at least 120° C. for at least 4 hours to provide a reaction mixture; and (4) reducing the reaction temperature of the reaction mixture to provide the MOF UiO-66 having a micropore volume greater than or equal to 0.45 cc/g and a crystal size of between about 20 nm and about 1000 nm. In an aspect, the terephthalic acid derivative is not soluble in water. In an aspect, the carboxylic acid is selected from 1,4-benzenedicarboxylate or derivative thereof, 1,2,4-benzene tricarboxylic acid, 1,2,4,5-benzene tetracarboxylic acid, 2-nitro-1,4, benzene dicarboxylic acid or mixtures thereof. In an aspect, the MOF UiO-66 has a surface area of between about 900 m²/g and about 1550 m²/g as measured by nitrogen BET.

Also provided are methods of making a MOF UiO-66 comprising reacting one or more of zirconium hydroxide acetate and zirconium hydroxide with a carboxylic acid or derivative thereof and acetic acid in a solvent to provide a reaction solution to produce the metal-organic framework MOF UiO-66 having a micropore volume at least 0.35 cc/gram. In an aspect, the carboxylic acid is 2-amino-1,4-benzene dicarboxylic acid. In an aspect, this method further comprises diluting the reaction solution with water in an amount less than or equal to 50 volume percent of the solvent to provide a diluted reaction solution. In an aspect, the diluted reaction solution to a reaction temperature of at least 85° C. In an aspect, the diluted reaction solution is heated for at least 4 hours.

In an aspect, the MOF UiO-66 produced by the present methods has a micropore volume of between about 0.1 and about 1.0 cubic centimeters per gram (“cc/g”). In an aspect, the MOF UiO-66 has a micropore volume between about 0.40 cc/g and about 0.60 cc/g. In an aspect, the concentration of terephthalic acid is between about 0.01, e.g., 0.1, to 5.0 moles per liter of solvent. In an aspect, the ratio of acetic acid to terephthalic acid is at least 20:1 mole:mole. In an aspect, the ratio of acetic acid to terephthalic acid is 24:1 mole:mole.

As described herein, the solvent can be dimethylformamide, ethanol, methanol, water or dimethylformamide, dimethylacetamide and/or “NPT” N-methylpyrrolidone.

In an aspect, the reaction solution is diluted with no greater than 60 volume percent water.

In an aspect, the reaction mixture yields between about 65 to about 95 molar percent of UiO-66 metal organic frameworks based on the molar limiting reagent by calculating the mass of the MOF on a dry basis.

The present methods are directed to making a defective UiO-66, that is, the MOF UiO-66 having missing linkers (ligands), nodes, and/or both in the structure. Up to a point, the structure is still synthesized despite these defects; but the defects impart new properties on the material which impact the performance of the material. Defect levels are challenging to measure directly, so the BET surface area and micropore volume of the material are used to determine the porosity of the material and approximate a defect level. The micropore volume has a direct impact on the separation performance for naphthene/paraffin separations. A method of manufacture to consistently produce MOF UiO-66 with the required defect level (which manifests itself in the BET surface area and micropore volume of the material) has not been known thus far, and especially not at the scales required for application.

The following non-limiting examples are provided to illustrate the disclosure.

### EXAMPLES

### Example 1: Method of Manufacture of High Pore Volume MOF UiO-66 at Larger Scale

With the methods described here, MOF UiO-66 was measured to have a micropore volume of at least 0.45 cc/g or 0.50 cc/g, and has been demonstrated to be useful in the class-based separation of naphthenes from paraffins. The present methods produce MOF UiO-66 in reaction solutions having a high concentration of acetic acid, for example, at least 15:1 acetic acid to terephthalic acid mole to mole.

Table 1 sets out the reactants used in a 2-liter (“2 L”) reactor-scale to make MOF UiO-66 as described herein.

TABLE 1
Smaller scale MOF UiO-66 Reaction Materials

| | Amount | Amount | Amount | MW | |
|---|---|---|---|---|---|
| | (g) | (mL) | (mmol) | (g/mol) | CAS |
| Terephthalic Acid | 49.72 | — | 299.6 | 166.13 | 100-21-0 |
| ZrOCₗ₂ 8H₂O | 69.19 | — | 214.7 | 322.25 | 13520-92-8 |
| Dimethylformamide | 668.10 | 703.3 | — | — | 68-12-2 |
| Glacial Acetic Acid | 442.6 | 421.6 | — | — | 64-19-7 |
| Total Charge | 1229.6 | | | | |

Dimethylformamide, glacial acetic acid, terephthalic acid, and ZrOCl2 8H₂O were charged to a stainless steel 2 L autoclave equipped with a paddle stirring blade in that order. The autoclave was sealed, stirred at 150 rpm, and heated to 150° C. for 24 hours to 120 hours. The reactor was cooled while stirring, opened, and a reaction mixture filtered to obtain a white solid. The solid white material (the reaction mixture comprising MOF UiO-66) was triturated in dimethylformamide for 4 hours, followed by trituration in acetone for 24 hours. The white solid material was filtered, collected, and dried in an oven at 115° C. for 12 hours.

Table 2 below sets out reactants used in a 5 Gallon reactor-scale to make MOF UiO-66.

TABLE 2
Larger scale MOF UiO-66 Reaction Materials

| | Amount | Amount | Amount | MW | |
|---|---|---|---|---|---|
| | (g) | (mL) | (mmol) | (g/mol) | CAS |
| Terephthalic Acid | 470.6 | — | 2835 | 166.13 | 100-21-0 |
| ZrOCₗ₂ 8H₂O | 654.8 | — | 2032 | 322.25 | 13520-92-8 |
| Dimethylformamide | 6323 | 6656 | — | | 68-12-2 |
| Glacial Acetic Acid | 4189 | 3990 | 69426 | | 64-19-7 |
| Total Charge | 11637.4 | | | | |

Dimethylformamide, glacial acetic acid, terephthalic acid, and ZrOC₁₂ 8H₂O were charged to a stainless steel 5 Gallon reactor (autoclave) equipped with a paddle stirring blade. The autoclave reactor was sealed, stirred at 150 rpm, and heated to 150° C. for 48 hours to provide a reaction mixture. The reactor was cooled while stirring the reaction mixture, opened, and the reaction mixture was filtered to produce a white solid. The white solid was triturated in dimethylformamide for 4 hours, followed by trituration in acetone for 24 hours. The white solid was filtered, collected, and dried in an oven at 115° C. for 12 hours.

Table 3 summarizes certain metrics of MOF UiO-66 produced at various scales under similar conditions. Reaction times did vary between the runs. However, reaction time did not appear to impact MOF UiO-66 produced or its micropore volume.

TABLE 3
Yields and Properties of MOF UiO-66 Synthesis

| | | BET | Micromi- | | Yield % | Yield |
|---|---|---|---|---|---|---|
| | | Surface | cropore | Crystal- | Based on | Desolvated |
| Autoclave | | Area | Volume | linity/ | Limiting | UiO-66 |
| Reactor | | (m²/g) | (cc/g) | Purity | Reagent | (g) |
| 600 | mL | 1304 | 0.50 | High | 71% | 12.7 |
| 2 | L | 1366 | 0.52 | High | 91% | 54.2 |
| 5 | Gallon | 1183 | 0.45 | High | 79% | 751 |

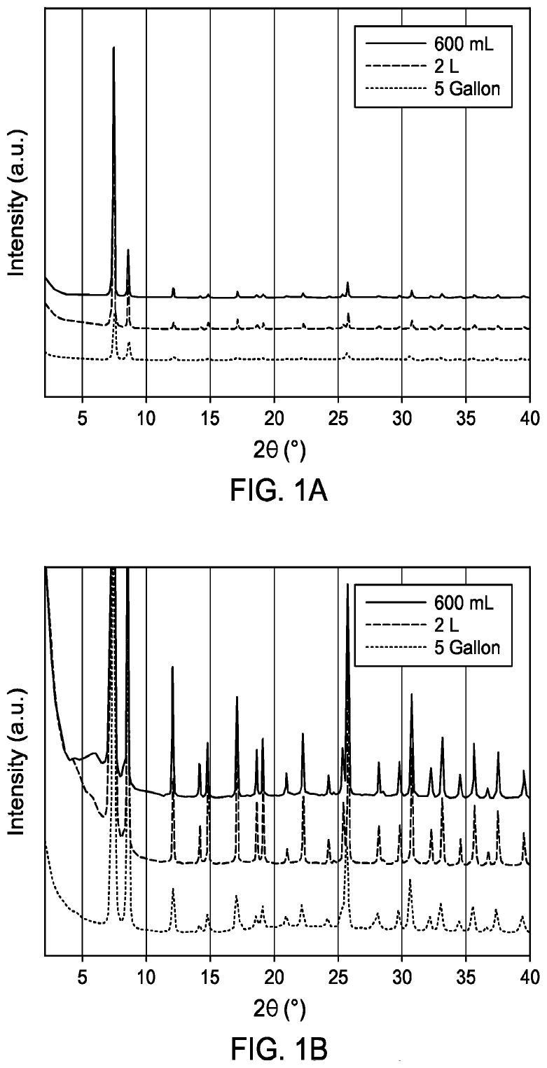

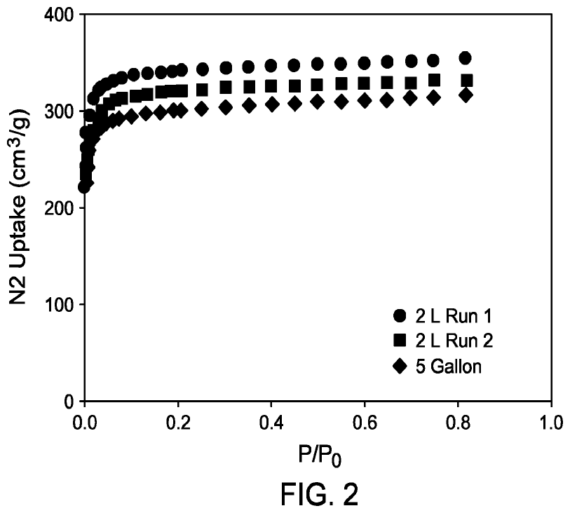

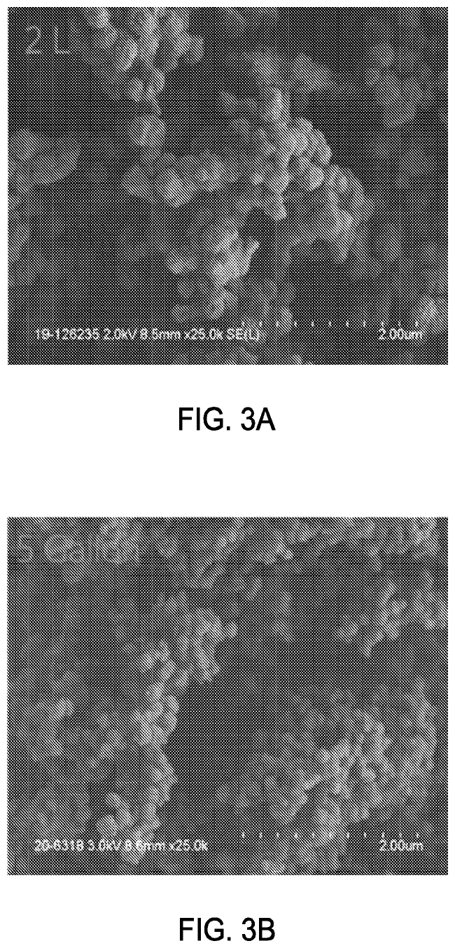

FIG. 1A and FIG. 1B provide a comparison of x-ray powder diffraction (“XRD”) patterns for MOF UiO-66 synthesized in a 600 mL, 2 L and 5 Gallon reactor. Each reaction mixture produced MOF UiO-66 with no impurities. Synthesis at all scales exhibited a MOF UiO-66 phase without additional phases present. BET surface area and micropore volume were both determined on the N₂ uptake at 77 K. FIG. 2 shows N₂ uptake at 77 K of multiple 2 L and 5 gallon scale runs producing MOF UiO-66. FIG. 3A and FIG. 3B provide comparisons of crystal sizes via SEM images for MOF UiO-66 produced in 2 L and 5 gallon reactors.

The present methods were shown to produce MOF UiO-66 having a micropore volume >0.45 cc/g (and optionally >0.50 cc/g) at large scale in a stainless-steel reactor. The molar ratio of acetic acid to terephthalic acid appear to enable synthesis of UiO-66 with large pore volumes at scale, which are likely a result of defects in MOF structure.

### Example 2: Alternative Metal Sources or Other Changes to Conditions for MOF UiO-66 Crystallization

In a typical synthesis, Zr(OCl)₂·8H₂O salt is used as a zirconium source. However, the chlorides contained in this salt can prove problematic for particular metallurgies in the reactor and subsequent downstream processing equipment. Commonly used stainless steels, such as 316 and 316 L, are susceptible to pitting in the presence of chloride. Having an alternative zirconium salt to mitigate this issue was found beneficial. In the present methods, a mixed acetate-hydroxide salt, Zr(OAc)ₓ(OH)₄₋ₓ(can also be written as Zr(OAc)ₓ(OH)_{y}, x+y≈4) was shown to provide MOF UiO-66 of similar quality as that made without the use of chlorides. Additionally, this acetate-hydroxide salt is potentially less expensive than the oxychloride, providing yet another benefit.

Tables 4 and 5 provide data for reaction solutions comprising Zr(OAc)ₓ(OH)₄₋ₓ, each method having slightly different conditions. Each of the reaction solutions produced a MOF UiO-66 phase, with certain differences in BET surface area and pore volume between the runs. To produce a reaction mixture, each reaction solution was stirred at 250 rpm and run at 150° C. for 24 hours. The reactions were carried out in a 600 mL stirred autoclave.

TABLE 4
Reaction Conditions for MOF UiO-66 Syntheses with Zr(OAc)ₓ(OH)₄₋ₓ

| | | ZrOCl₂ | | | Glacial | | |
|---|---|---|---|---|---|---|---|
| | BDC | 8H₂O | Zr(OAc)ₓ(OH)₄₋ₓ | DMF | Acetic Acid | Time | Temperature |
| Rxn | (g) | (g) | (g) | (mL) | (mL) | (h) | (° C.) |
| 1 | 14.93 | 0 | 15.69 | 211 | 126.5 | 24 | 150 |
| 2 | 21.43 | 0 | 15.69 | 211 | 126.5 | 24 | 150 |
| 3 | 14.93 | 0 | 15.69 | 211 | 207 | 24 | 150 |
| 4 | 14.93 | 20.78 | 0 | 211 | 207 | 24 | 150 |

TABLE 5
Properties and Yields for MOF UiO-66
Synthesis Using Zr(OAc)ₓ(OH)₄₋ₓ

| | | BET | Micromi- | |
|---|---|---|---|---|
| | | Surface | cropore | Crystal- |
| | | Area | Volume | linity/ |
| Description | Rxn* | (m²/g) | (cc/g) | Purity |
| Base case | 1 | 957 | 0.35 | High |
| Zr(OAc)ₓ(OH)₄₋ₓ Synthesis | | | | |
| Excess Ligand | 2 | 999 | 0.37 | High |
| Excess Acetic Acid | 3 | 1131 | 0.42 | High |
| Excess Acetic Acid with ZrOCl₂ | 4 | 1517 | 0.61 | High |

*The Rxn number from Table 4.

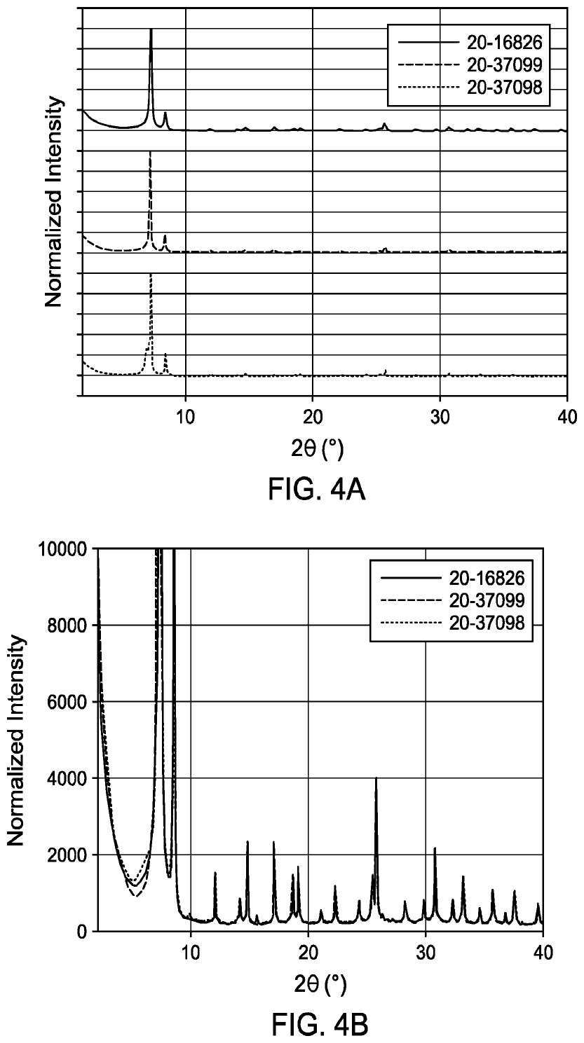

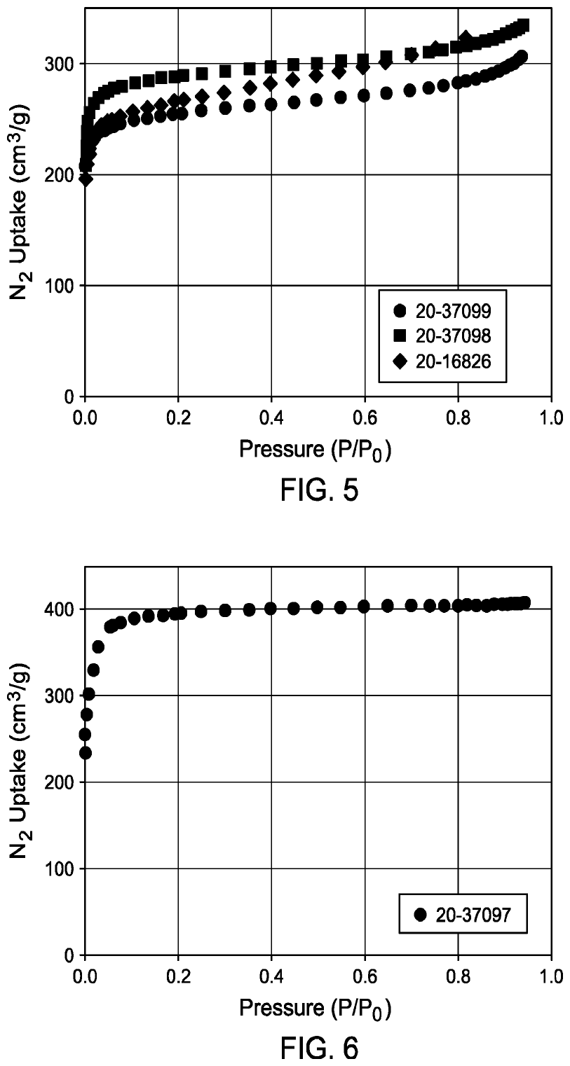

FIG. 4A and FIG. 4B provide powder X-ray diffraction patterns of MOF UiO-66 synthesized with Zr(OAc)ₓ(OH)₄₋ₓ. Both graphs show the same data, the right graph is overlaid and zoomed in for clarity. Powder x-ray diffraction patterns indicate that the reaction solutions comprising Zr(OAc)ₓ(OH)₄₋ₓ produced materials having a MOF UiO-66 phase only. BET surface areas and micropore volumes of reaction mixtures produced were adequate, especially for reaction solutions having excess acid. Each sample produced the correct phase with relatively high pore volume, especially for Rxn 3 with excess acetic acid. As shown in FIG. 5, the N₂ adsorption isotherms at 77 K were used to calculate the BET surface areas for MOF UiO-66 samples synthesized using Zr(OAc)ₓ(OH)₄₋ₓ as a starting material.

Changes to the synthetic protocol (methods of making MOF UiO-66) resulted in different micropore volumes. As shown in Table 5, comparisons between conditions demonstrate that increases in micropore volume result when using the Zr(OAc)ₓ(OH)₄₋ₓ. Pore volumes as high as 0.42 cc/g were synthesized with excess acetic acid in the reaction solution. See, Rxns 4 and 5, Table 4.

Furthermore, increasing the acid content when using ZrOCl₂ (Table 4 Rxn 6) increased the micropore volume to 0.61 cc/g. FIG. 6 shows N₂ adsorption isotherm at 77 K used to calculate the micropore volume and BET surface area of MOF UiO-66 synthesized with ZrOCl₂ with a reaction solution having a high acetic acid content. Increasing acid in a reaction solution improved micropore volume of synthesized MOF UiO-66. Increasing micropore volume can boost separation properties of MOF UiO-66.

### Example 3: Addition of Water to Synthesis and Modulation of Acid Content

With a metal to ligand ratio and overall concentration held constant, small-scale trials were conducted with reagents traditionally used as shown in Table 6.

TABLE 6
Reaction Conditions for Water Inclusion
in High Pore Volume MOF UiO-66 Synthesis

| | | ZrOCl₂ | | Glacial | | |
|---|---|---|---|---|---|---|
| | BDC | 8H₂O | DMF | Acetic Acid | Water | Temperature |
| Rxn | (g) | (g) | (mL) | (mL) | (mL) | (° C.) |
| 1 | 0.442 | 0.615 | 5.625 | 3.375 | 1 | 100 |
| 2 | 0.442 | 0.615 | 5.0 | 3.0 | 2 | 100 |
| 3 | 0.442 | 0.615 | 3.75 | 2.25 | 4 | 100 |
| 4 | 0.442 | 0.615 | 3.125 | 1.875 | 5 | 100 |
| 5 | 0.442 | 0.615 | 5.0 | 3.75 | 2 | 100 |
| 6 | 0.442 | 0.615 | 3.125 | 3.75 | 5 | 100 |

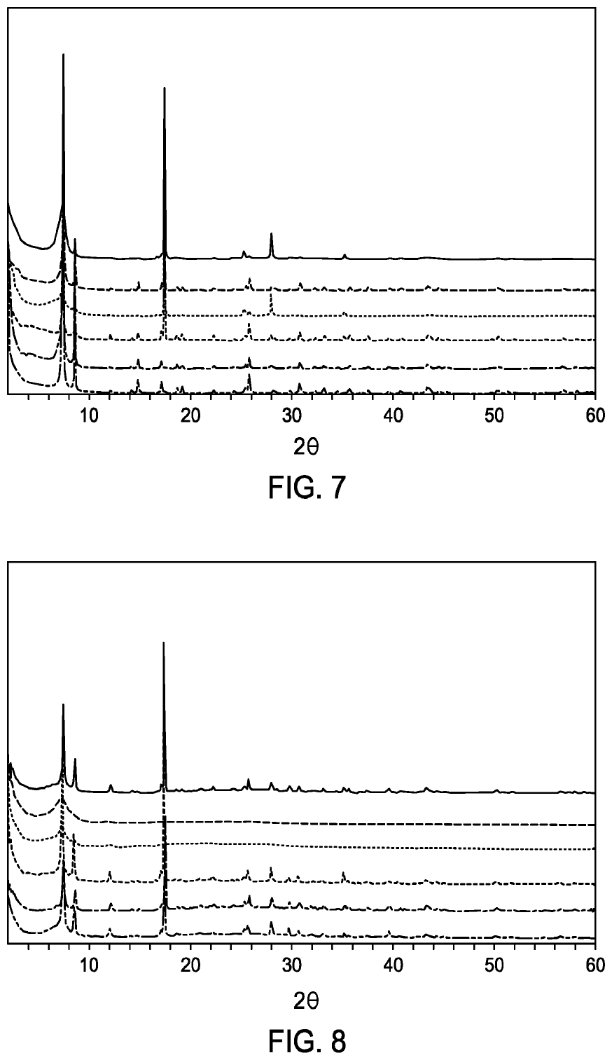

FIG. 7 shows the powder X-ray diffraction patterns of the syntheses of Table 6. In diluting the reaction solution with water, the ratio of acetic acid to linker decreases. Under the conditions set out in Table 6, no greater than 40 wt. % water could be incorporated in the reaction solution without causing significant broadening of the reflections at ˜8.5°2Θ. With a greater water concentration, reflections and large amorphous or partially crystalline features occurred at a similar angle.

However, with other experiments, as a starting point, crystalline materials from the reaction solutions were obtained for reaction solutions comprising 50 vol. % water or more. Water content of the reaction solution was increased up to 60 vol % through modulation of reactant, acetic acid to linker, concentrations to provide crystalline MOF UiO-66.

FIG. 8 shows powder X-ray diffraction patterns of the MOF UiO-66 syntheses with varied acid concentration set out in Table 7 below.

TABLE 7
Varying Acid Concentration in MOF UiO-66 Synthesis

| | | | | Glacial | | | |
|---|---|---|---|---|---|---|---|
| | | ZrOCl₂ | | Acetic | | | Temper- |
| | BDC | 8H₂O | DMF | Acid | Water | | ature |
| Rxn | (g) | (g) | (mL) | (mL) | (mL) | HOAc:L | (° C.) |
| 1 | 0.442 | 0.615 | 3.125 | 1.875 | 5 | 8 | 100 |
| 2 | 0.442 | 0.615 | 3.125 | 1.27 | 5 | 6 | 100 |
| 3 | 0.442 | 0.615 | 3.75 | 0.85 | 5 | 4 | 100 |
| 4 | 0.442 | 0.615 | 3.125 | 0.42 | 5 | 2 | 100 |
| 5 | 0.442 | 0.615 | 2.5 | 1.27 | 6 | 6 | 100 |
| 6 | 0.442 | 0.615 | 2.5 | 0.85 | 6 | 4 | 100 |

Incorporation of water into a reaction solution can cause unreacted terephthalic acid to remain in the reaction mixture comprising MOF UiO-66. Traditionally, polar aprotic solvents are used to dissolve any unreacted organic component(s). However, using DMF to wash MOF UiO-66 materials obviates the utility of water-diluted reaction mixtures.

We observed a reflection at 17° (corresponding to crystalline terephthalic acid) when 40 vol % water was used in the reaction solution. As shown in FIG. 8, the bottom pattern represents material synthesized. The second to bottom trace showing a total removal of the terephthalic acid peak was the result of traditional DMF washing. Taking advantage of the acid-base properties of the organic linker, we used aqueous ammonia to selectively dissolve out the impurities. MOF UiO-66 is sensitive to high pH. Therefore, a controlled titration must be conducted.

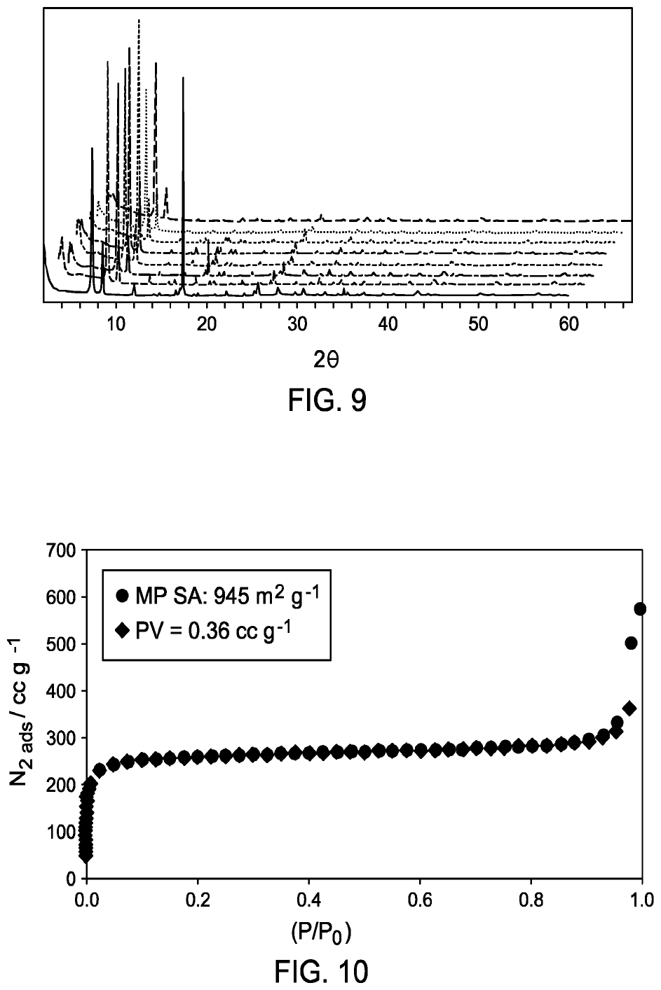

To test this, 800 mg of MOF UiO-66 was suspended in 10 mL of water and treated with 0.2 mL, 0.4 mL, 0.4 mL (with extended reaction times), 0.6 mL, 0.6 mL (with extended reaction times), and 0.8 mL. See, FIG. 9, third trace from the bottom. FIG. 9 shows powder X-ray diffraction patterns of MOF UiO-66 washed in various ways. We observed that 0.4 mL of NH₄OH, even with extended reaction times, did not completely dissolve the unreacted terephthalic acid. On the other hand, 0.6 mL can completely remove the unreacted terephthalic acid when allowing for extended reaction times.

Gas adsorption analysis was conducted on a sample of UiO-66 that was synthesized using a 40% water-based solvent and washed with a minimal amount of ammonium hydroxide to completely remove the terephthalic acid. FIG. 10 provides N₂ adsorption isotherm at 77 K for MOF UiO-66 made with a reaction solution comprising 40% water.

When numerical lower limits and numerical upper limits are listed herein, ranges from any lower limit to any upper limit are contemplated. Although the present disclosure has been described in terms of specific aspects, it is not so limited. Suitable alterations/modifications for operation under specific conditions should be apparent to those skilled in the art. It is therefore intended that the following claims be interpreted as covering all such alterations/modifications as fall within the true spirit/scope of the disclosure.

Additionally or alternately, the invention relates to:

Embodiment 1. A method of making a MOF UiO-66 comprising:
reacting zirconium oxychloride with terephthalic acid or derivative thereof and acetic acid in a solvent to provide a reaction solution;
diluting the reaction solution with at least about 10 vol. % of water to provide a diluted reaction solution;
heating the diluted reaction solution to a reaction temperature of at least 120° C. for at least 4 hours to provide a reaction mixture; and
reducing the reaction temperature of the reaction mixture to provide the MOF UiO-66.

Embodiment 2. The method of embodiment 1, wherein the MOF UiO-66 has a micropore volume greater than or equal to 0.45 cc/g and a crystal size of between about 20 nm and about 1000 nm.

Embodiment 3. The method of embodiment 1 or 2, wherein the terephthalic acid derivative is not soluble in water.

Embodiment 4. The method of any one of embodiments 1 to 3, wherein the terephthalic acid derivative is selected from 1,4-benzenedicarboxylate or derivative thereof, 1,2,4-benzene tricarboxylic acid, 1,2,4,5-benzene tetracarboxylic acid, 2-nitro-1,4, benzene dicarboxylic acid or mixtures thereof.

Embodiment 5. The method of any one of embodiments 1 to 4, wherein the MOF UiO-66 has a surface area of between about 900 m²/g and about 1550 m²/g as measured by nitrogen BET.

Embodiment 6. A method of making a MOF UiO-66 comprising: reacting one or more of zirconium hydroxide acetate and zirconium hydroxide with a carboxylic acid or derivative thereof and acetic acid in a solvent to provide a reaction solution to produce the metal-organic framework MOF UiO-66.

Embodiment 7. The method of embodiment 6, wherein the MOF UiO-66 has a micropore volume of at least about 0.35 cc/gram.

Embodiment 8. The method of embodiment 6 or 7, wherein the carboxylic acid is 2-amino-1,4-benzene dicarboxylic acid.

Embodiment 9. The method of any one of embodiments 6 to 8, further comprising diluting the reaction solution with water in an amount less than or equal to about 50 volume percent of the solvent to provide a diluted reaction solution.

Embodiment 10. The method of embodiment 9, further comprising heating the diluted reaction solution to a reaction temperature of at least 85° C.

Embodiment 11. The method of embodiment 10, wherein the diluted reaction solution is heated for at least 4 hours.

Embodiment 12. The method of any one of the preceding embodiments, wherein the MOF UiO-66 has a micropore volume of between about 0.1 cc/g and about 1.0 cc/g.

Embodiment 13. The method of embodiment 12, wherein the MOF UiO-66 has a micropore volume between about 0.40 cc/g and about 0.60 cc/g.

Embodiment 14. The method of any one of the preceding embodiments, wherein the solvent is selected from dimethylformamide, ethanol, methanol, water or diethylformamide, dimethylacetamide and “NPT” N-methylpyrrolidone.

Embodiment 15. The method of any one of the preceding embodiments, wherein concentration of terephthalic acid is between about 0.01 mole to about 5.0 mole per liter of solvent.

Embodiment 16. The method of any one of the preceding embodiments, wherein the reaction mixture yields between about 65 to about 95 molar percent of UiO-66 metal organic frameworks based on the molar limiting reagent by calculating the mass of the MOF on a dry basis.

Embodiment 17. The method of any one of the preceding embodiments, wherein the reaction solution is diluted with no greater than about 60 volume percent water.

Embodiment 18. The method of any one of the preceding embodiments, further comprising the step of separating the metal-organic frameworks from the reaction solution.

Embodiment 19. The method of any one of the preceding embodiments, wherein the ratio of acetic acid to terephthalic acid is at least about 20 moles to about 1 mole.

Embodiment 20. The method of any one of the preceding embodiments, wherein the ratio of acetic acid to terephthalic acid is about 24 moles to about 1 mole.

1. A method of making a MOF UiO-66 comprising:
reacting zirconium oxychloride with terephthalic acid or derivative thereof and acetic acid in a solvent to provide a reaction solution;
diluting the reaction solution with at least about 10 vol. % of water to provide a diluted reaction solution;
heating the diluted reaction solution to a reaction temperature of at least 120° C. for at least 4 hours to provide a reaction mixture; and
reducing the reaction temperature of the reaction mixture to provide the MOF UiO-66.

2. The method of claim 1, wherein the MOF UiO-66 has a micropore volume greater than or equal to 0.45 cc/g and a crystal size of between about 20 nm and about 1000 nm.

3. The method of claim 1, wherein the terephthalic acid derivative is not soluble in water.

4. The method of any one of claim 1, wherein the terephthalic acid derivative is selected from 1,4-benzenedicarboxylate or derivative thereof, 1,2,4-benzene tricarboxylic acid, 1,2,4,5-benzene tetracarboxylic acid, 2-nitro-1,4, benzene dicarboxylic acid or mixtures thereof.

5. The method of any one of claim 1, wherein the MOF UiO-66 has a surface area of between about 900 m²/g and about 1550 m²/g as measured by nitrogen BET.

6. A method of making a MOF UiO-66 comprising:
reacting one or more of zirconium hydroxide acetate and zirconium hydroxide with a carboxylic acid or derivative thereof and acetic acid in a solvent to provide a reaction solution to produce the metal-organic framework MOF UiO-66.

7. The method of claim 6, wherein the MOF UiO-66 has a micropore volume of at least about 0.35 cc/gram.

8. The method of claim 6, wherein the carboxylic acid is 2-amino-1,4-benzene dicarboxylic acid.

9. The method of any one of claim 6, further comprising diluting the reaction solution with water in an amount less than or equal to about 50 volume percent of the solvent to provide a diluted reaction solution.

10. The method of claim 9, further comprising heating the diluted reaction solution to a reaction temperature of at least 85° C.

11. The method of claim 10, wherein the diluted reaction solution is heated for at least 4 hours.

12. The method of claim 1, wherein the MOF UiO-66 has a micropore volume of between about 0.1 cc/g and about 1.0 cc/g.

13. The method of claim 12, wherein the MOF UiO-66 has a micropore volume between about 0.40 cc/g and about 0.60 cc/g.

14. The method of claim 1, wherein the solvent is selected from dimethylformamide, ethanol, methanol, water or diethylformamide, dimethylacetamide and “NPT” N-methylpyrrolidone.

15. The method of claim 1, wherein concentration of terephthalic acid is between about 0.01 mole to about 5.0 mole per liter of solvent.

16. The method of claim 1, wherein the reaction mixture yields between about 65 to about 95 molar percent of UiO-66 metal organic frameworks based on the molar limiting reagent by calculating the mass of the MOF on a dry basis.

17. The method of claim 1, wherein the reaction solution is diluted with no greater than about 60 volume percent water.

18. The method of claim 1, further comprising the step of separating the metal-organic frameworks from the reaction solution.

19. The method of claim 1, wherein the ratio of acetic acid to terephthalic acid is at least about 20 moles to about 1 mole.

20. The method of claim 1, wherein the ratio of acetic acid to terephthalic acid is about 24 moles to about 1 mole.
